(19) United States
(12) Patent Application Publication
(10) Pub. No.: US 2026/0172761 A1
(43) Pub. Date: Jun. 18, 2026

(54) HEARING DEVICE WITH ADAPTIVE DELAY AND RELATED METHODS

(71) Applicant: GN Hearing A/S, Ballerup (DK)

(72) Inventor: Thorkild Find PEDERSEN, Valby (DK)

(73) Assignee: GN Hearing A/S, Ballerup (DK)

(21) Appl. No.: 19/405,349

(22) Filed: Dec. 1, 2025

(30) Foreign Application Priority Data
Dec. 13, 2024 (EP) 24219957

(51) Int. Cl. H04R 25/00

(52) U.S. Cl. CPC H04R 25/43; H04R 25/554; H04R 2225/43; H04R 2420/01; H04R 2420/07

(57) ABSTRACT

A hearing device comprises an interface, and a processor. The hearing device is configured to obtain a microphone input signal from a microphone of the hearing device. The hearing device is configured to obtain a transceiver input signal from a transceiver of the interface. The hearing device is configured to determine a time shift between the microphone input signal and the transceiver input signal. The hearing device is configured to determine a time delay based on the time shift. The hearing device is configured to process the transceiver input signal for provision of an output signal, wherein to process the transceiver input signal comprises to apply the time delay to the transceiver input signal for provision of a delayed transceiver input signal. The hearing device is configured to provide the output signal to a receiver of the hearing device for provision of an audio output signal.

### RELATED APPLICATION DATA

This application claims priority to, and the benefit of, European Ser. No. 24/219,957 filed on Dec. 13, 2024. The entire disclosure of the above application is expressly incorporated by reference herein.

### FIELD

The present disclosure relates to a hearing device and related methods including a method of operating a hearing device. In particular, hearing devices and methods utilizing adaptive delay, e.g. for determining a time delay, are presented.

### BACKGROUND

Hearing devices receiving wireless audio broadcasting from e.g. a microphone attract increased attention.

### SUMMARY

Challenges remain due to the broadcasted audio also being received by the microphones however typically shifted in time leading to distortions in processing and playback.

Accordingly, there is a need for hearing devices and methods with improved processing and playback of streamed audio.

A hearing device is disclosed, the hearing device, such as a first hearing device, comprising an interface and a processor. The hearing device may also be denoted a first hearing device and is configured to obtain a microphone input signal, e.g. from a microphone of the hearing device. The (first) hearing device is configured to obtain a transceiver input signal, e.g. from a transceiver of the interface. The (first) hearing device is configured to determine a time shift between the microphone input signal and the transceiver input signal. The (first) hearing device, such as the processor, is configured to determine a time delay based on the time shift. The (first) hearing device, such as the processor, is configured to process the transceiver input signal for provision of an output signal. To process the transceiver input signal may comprise to apply the time delay to the transceiver input signal for provision of a delayed transceiver input signal. The (first) hearing device, such as the processor, is configured to provide the output signal to a receiver of the hearing device, e.g. for provision of an audio output signal. The time delay may be determined to align the audio output signal with an acoustic input signal, e.g. received by microphone and/or a microphone input signal.

Method of operating a hearing device is also disclosed. The hearing device, such as a first hearing device, comprises an interface, and a processor. The method comprises obtaining, e.g. from a microphone of the hearing device, a microphone input signal. The method further comprises obtaining, e.g. from a transceiver of the interface, a transceiver input signal. The method comprises determining, e.g. using the processor, a time shift between the microphone input signal and the transceiver input signal. The method comprises determining, e.g. using the processor, a time delay based on the time shift. The method comprises processing, e.g. using the processor, the transceiver input signal for provision of an output signal. Processing the transceiver input signal may comprise applying the time delay to the transceiver input signal for provision of a delayed transceiver input signal. The method optionally comprises providing the output signal to a receiver of the hearing device for provision of an audio output signal. The time delay may be determined to align the audio output signal with an acoustic input signal.

The acoustic input signal may be an ambient sound, also known as background noise, natural sound, and/or atmospheric sound from the surroundings.

Presetting of a time delay to account for any estimated delays involved with wireless audio broadcasting from e.g. a microphone, may therefore be avoided since the time delay is determined by the hearing device. If there are variations in the wireless audio broadcasting and the acoustic input signal, the time delay is adjusted accordingly, i.e. adaptively, such as substantially in real-time, by the hearing device by the time delay being determined to align the audio output signal with the acoustic input signal.

Also disclosed is a hearing system comprising a first hearing device and a second hearing device. The first hearing device may be a (first) hearing device as disclosed herein. The second hearing device may be a (second) hearing device as disclosed herein.

### BRIEF DESCRIPTION OF THE DRAWINGS

The above and other features and advantages of the present invention will become readily apparent to those skilled in the art by the following detailed description of exemplary embodiments thereof with reference to the attached drawings, in which:

FIG. 1 schematically illustrates an exemplary hearing system,

FIG. 2 shows a flow chart of an example method,

FIG. 3 schematically illustrates an exemplary hearing system according to the disclosure,

FIG. 4 schematically illustrates an exemplary hearing system according to the disclosure.

### DETAILED DESCRIPTION

Various exemplary embodiments and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the embodiments. They are not intended as an exhaustive description of the invention or as a limitation on the scope of the invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

A hearing device is disclosed. The hearing device may be configured to be worn at an ear of a user. The hearing device may be a hearable. The hearing device may be a hearing aid, wherein the processor is configured to compensate for a hearing loss of a user, e.g. based on one or more input signals, such as the transceiver input signal.

In one or more examples, the hearing device may be an earbud, a headphone, or a hearing aid, etc.

The hearing device may be of the behind-the-ear (BTE) type, in-the-ear (ITE) type, in-the-canal (ITC) type, receiver-in-canal (RIC) type, receiver-in-the-ear (RITE) type, or microphone-and-receiver-in-the-ear (MaRIE) type. The hearing aid may be a binaural hearing aid. The binaural hearing aid may be part of a binaural hearing system. The binaural hearing system may comprise a first hearing aid and a second hearing aid, wherein the first hearing aid and/or the second hearing aid may be the hearing device(s) as disclosed herein.

The hearing device comprises an interface and a processor. The hearing device may further comprise a memory.

The hearing device/interface may be configured for wireless communication with one or more audio devices also denoted audio sources and one or more hearing devices, such as a contralateral hearing device. The hearing device/interface may be configured for wireless communication with one or more accessory devices, such as a tablet computer, a laptop computer, a smartphone, and/or a smart watch. Accordingly, the hearing device/interface may comprise a transceiver and/or transceiver module. An accessory device may operate, be, and/or function as an audio device. The hearing device/interface/transceiver module optionally comprises an antenna for converting one or more wireless input signals, e.g. a first wireless input signal and/or a second wireless input signal, to antenna output signal(s). The wireless input signal(s) may comprise or be representative of audio data, e.g. the first audio data and/or second audio data. In other words, the audio data may be encoded in the wireless input signal(s). The wireless input signal(s) may origin from external audio source(s), such as audio devices, e.g. spouse microphone device(s), wireless TV audio transmitter(s), music player(s), car(s), doorbell(s), mobile phone(s), smart watch(es), and wireless audio transmitters(s), such as public wireless audio transmitter(s), e.g. in airports, train stations, stadiums, cinemas, shopping malls, lectures, during religious services e.g. in churches, and/or arenas. The wireless input signal(s) may origin from one or more accessory devices. The term spouse microphone is used here as a term to refer to a microphone, typically a directional microphone, which is arranged distant from the hearing device worn by the hearing device user, i.e. the spouse microphone is not arranged in the hearing device. The spouse microphone will typically be worn by a spouse to the hearing device user, or be placed on a surface, such as table in front of the spouse for capturing the sounds, e.g. voice, sounds, speech or talk from the spouse, to be transmitted wirelessly to the hearing device of the hearing device user. The person whose sounds or voice is captured by the spouse microphone may be a spouse to the hearing device user, a family member, a friend, a colleague, a business partner etc., i.e. any person which the hearing device user wishes to clearly hear the sounds e.g. talk from, e.g. in an environment with many sounds, such as in a restaurant, in an office facility, at home, in a garden etc.

The hearing device/interface/transceiver module comprises a radio transceiver coupled to the antenna for converting the antenna output signal to audio data. Wireless signals from different external sources may be multiplexed in the radio transceiver to audio data or provided as separate audio data on separate transceiver output terminals of the radio transceiver. The hearing device may comprise a plurality of antennas and/or an antenna may be configured to be operate in one or a plurality of antenna modes. The transceiver input signal optionally comprises a first transceiver input signal representative of the first wireless signal from a first external source.

The hearing device may comprise a set of transducers, such as microphones. The hearing device may comprise a set of microphones. The set of microphones may comprise one or more microphones. The set of microphones normally comprises a first microphone for provision of a first microphone input signal and/or a second microphone for provision of a second microphone input signal. The set of microphones may comprise N microphones for provision of N microphone signals, wherein N is an integer in the range from 1 to 10. In one or more exemplary hearing devices, the number N of microphones is two, three, four, five or more. The set of microphones may comprise a third microphone for provision of a third microphone input signal.

The hearing device comprises a processor for processing audio data, such as the microphone input signal, pre-processed transceiver input signal and/or pre-processed microphone input signal(s). The processor provides an electrical output signal based on the input signals/audio data to the processor. Input terminal(s) of the processor are optionally connected to respective output terminals of the pre-processor. For example, a transceiver input terminal of the processor may be connected to a transceiver output terminal of the pre-processor or transceiver module. One or more microphone input terminals of the processor may be connected to respective one or more microphone output terminals of the pre-processor or microphone(s).

The hearing device may comprise a processor for processing transducer input data, such as microphone input data/signal, and providing an electrical output signal based on the transducer input data, such as the microphone input data/signal. The processor may be configured to apply a neural network to a network input for provision of a network output, the network input based on the transducer input data, such as the microphone input data/signal, for example based on the first transducer input signal and/or the second transducer input signal. The first transducer input signal may for example be a first microphone input signal from a first microphone. The second transducer input signal may for example be a second microphone input signal from a second microphone. In other words, the first microphone input signal may constitute the first transducer input signal and/or the second microphone input signal may constitute the second transducer input signal. The transducer input data, such as microphone input data/signal, may be pre-processed, e.g. in a pre-processor external to or integrated in the processor, before being processed for provision of the electrical output signal, e.g. fed as network input to the neural network.

The electrical output signal may be based on, e.g. being a function of the network output. The hearing device may comprise a receiver for converting the electrical output signal to an audio output signal.

The processor may for example be configured to obtain, e.g., from or via the set of input transducers, the transducer input data. In other words, the processor may for example be configured to receive and/or retrieve, e.g., from or via the set of input transducers, the transducer input data, such as microphone input signal(s) from respective microphone(s).

The processor may for example be configured to generate, e.g., based on the transducer input data, an electrical output signal. In one or more examples, the processor may be configured to perform hearing loss compensation processing on the transducer input data. For example, the processor may be configured to generate the electrical output signal, e.g., including to apply the neural network to the network input based on the transducer input data and/or transceiver input data.

The electrical output signal may for example be an electrical output signal of the processor. The electrical output signal may for example be seen as an electrical signal provided by the processor as an output.

The receiver may for example be configured to obtain, e.g., receive and/or retrieve the electrical output signal, such as from the processor. The receiver may for example be configured to determine, such as generate the audio output signal, e.g., based on the electronic output signal. In some examples, the receiver may be configured to provide, such as output, the audio output signal.

A hearing device is disclosed. The hearing device, such as a first hearing device, comprising an interface, and a processor. The (first) hearing device is configured to obtain a microphone input signal, e.g. from a microphone of the hearing device. The (first) hearing device is configured to obtain a transceiver input signal, e.g. from a transceiver of the hearing device. The (first) hearing device, such as the processor, is configured to determine a time shift between the microphone input signal and the transceiver input signal. The (first) hearing device, such as the processor, is configured to determine a time delay based on the time shift. The (first) hearing device, such as the processor, is configured to process the transceiver input signal for provision of an output signal. To process the transceiver input signal may comprise to apply the time delay to the transceiver input signal for provision of a delayed transceiver input signal. The (first) hearing device is configured to provide the output signal to a receiver of the hearing device, e.g. for provision of an audio output signal. The time delay may be determined to align the audio output signal with an acoustic input signal.

In one or more example hearing devices, a hearing device, also denoted first hearing device, comprises an interface, and a processor, wherein the hearing device is configured to obtain a microphone input signal from a microphone of the hearing device; obtain a transceiver input signal from a transceiver of the hearing device; determine a time shift between the microphone input signal and the transceiver input signal; determine a time delay based on the time shift; process the transceiver input signal for provision of an output signal, wherein to process the transceiver input signal comprises to apply the time delay to the transceiver input signal for provision of a delayed transceiver input signal; and provide the output signal to a receiver of the hearing device for provision of an audio output signal, wherein the time delay is determined to align the audio output signal with an acoustic input signal.

The microphone input signal may be a combination, e.g. by beamforming, addition, linear combination, of a plurality of microphone input signals from respective microphones. For example, the microphone input signal may be a combination of a first microphone input signal from a first microphone of the interface, and a second microphone input signal from a second microphone of the interface. In other words, the microphone input signal may be based on a first microphone input signal from a first microphone of the interface, and a second microphone input signal from a second microphone of the interface.

Method of operating a hearing device is also disclosed. The hearing device, such as a first hearing device, comprises an interface, and a processor. The method comprises obtaining, e.g. from a microphone of the hearing device, a microphone input signal. The method further comprises obtaining, e.g. from a transceiver of the hearing device, a transceiver input signal. The method comprises determining, e.g. using the processor, a time shift between the microphone input signal and the transceiver input signal. The method comprises determining, e.g. using the processor, a time delay based on the time shift. The method comprises processing, e.g. using the processor, the transceiver input signal for provision of an output signal. Processing the transceiver input signal may comprise applying the time delay to the transceiver input signal for provision of a delayed transceiver input signal. The method further comprises providing the output signal to a receiver of the hearing device for provision of an audio output signal. The time delay may be determined to align the audio output signal with an acoustic input signal.

In one or more example methods, a method operating a hearing device, such as a first hearing device comprising an interface, and a processor, comprises obtaining, from a microphone of the hearing device, a microphone input signal; obtaining, from a transceiver of the hearing device, a transceiver input signal; determining a time shift between the microphone input signal and the transceiver input signal; determining a time delay based on the time shift; processing the transceiver input signal for provision of an output signal, wherein processing the transceiver input signal comprises applying the time delay to the transceiver input signal for provision of a delayed transceiver input signal; and providing the output signal to a receiver of the hearing device for provision of an audio output signal, wherein the time delay is determined to align the audio output signal with an acoustic input signal.

In one or more examples, the time delay is determined such that a time shift between the microphone input signal and the transceiver input signal is within a desired range, such as within the range from 2 ms to 50 ms, such as within the range from 5 ms to 30 ms. The time delay may be selected such that a time shift between the microphone input signal and the transceiver input signal is between 2 ms and 50 ms, such as between 5-10ms, such as between 5 ms and 15 ms, such as between 5 ms and 20 ms, such as between 10 ms and 20 ms, such as between 15 ms and 25 ms, such as between 20 ms and 30 ms, such as between 30 ms and 40 ms, such as between 40 ms and 50 ms. This time shift or time lag between the two signals may be performed such that the hearing device user will hear the microphone input signal from the hearing aid microphones in some appropriate time before hearing the microphone input signal from e.g. a (spouse) microphone. In one or more exemplary hearing devices, the time delay may be selected such that a time shift between the first and the second summing signals is between 5 ms and 30 ms.

In one or more examples, to determine a time delay comprises to determine whether the microphone input signal is before the transceiver input signal. In response to a determination that the microphone input signal is before the transceiver input signal, the time shift and/or the time delay is optionally set to zero. Thus, in one or more examples, to determine a time delay comprises to determine whether the microphone input signal is before the transceiver input signal and, in response to a determination that the microphone input signal is before the transceiver input signal, set the time delay to zero.

In one or more examples, the transceiver input signal comprises a transmitter delay control signal, e.g. indicative of a time delay in the transmitter, such as accessory device. To determine the time delay may be based on the transmitter delay control signal.

In one or more examples, the time delay is based on an electrical delay. The electrical delay may be comprising one or more of a receiver delay associated with the receiver and a processing delay associated with the processor. Thus, the electrical delay may comprise a receiver delay associated with the receiver. Alternatively, or in combination, the electrical delay may comprise a processing delay associated with the processor.

In one or more examples, to determine a time shift between the microphone input signal and the transceiver input signal comprises performing a cross correlation function on the microphone input signal and the transceiver input signal. The cross correlation may be obtained by summing of squared differences and summing of absolute differences. The cross correlation, the summing of squared differences and the summing of absolute differences may be termed time shift estimators. In the cross correlation and/or in the summing of squared differences and/or in the summing of absolute differences signals may be multiplied, added, subtracted, divided etc. If the difference in amplitude between two input signals in e.g. the cross correlation is large, then the cross correlation may not be optimal. Accordingly, the processor (time shift estimator) may therefore be configured to normalise one or more of the input signals before and/or after the cross correlation in order to obtain signals with a similar amplitude, thereby providing an optimal cross correlation. The processor may be configured to transmit time shift between the transceiver input signal and the microphone input signal. The processor in the hearing device may be configured to determine and apply a time delay at a fixed or variable frequency. For example, the time delay may be determined and/or updated at an update frequency of 1 Hz or less. A suitable update frequency may be in the range from 0.1 Hz to 10 Hz, such as in the range from 0.5 Hz to 2 Hz, e.g. 1 Hz, e.g. in order to balance the requirement to adapt to changing input signals (change in position) and the limited power resources of a hearing device. In one or more examples, the time delay may be adjusted based on a user input and/or an update criterion and/or an update event e.g. from another hearing device. The processor may be configured to determine whether the time delay changes more than a threshold value, and optionally apply updated time delay, if the change(s) in time delay meets an update criterion, e.g. if the change in the time delay applied is larger than the threshold value. An algorithmic processing of the processor may overrule the change and/or update in time delay, e.g. if the time delay changes more than the predetermined threshold value, as this may, possibly erroneously be perceived by the hearing device user as, if a person (spouse) wearing a (spouse) microphone providing the transceiver input signal moves too much too fast. Thus, the two input signals would then be out of synchronization, which is not optimal for the hearing device user to listen to.

In one or more examples, the time delay D_time is given by D_time=S_time−D_elec, where S_time is the time shift and D_elec is an electrical delay in the hearing device. The time delay may be D_time=0 if S_time<D_elec. Thus, the time delay D_time may be set to zero if the electrical delay is larger than the time shift S_time.

In one or more examples, the time delay D_time is given by D_time=S_time−D_elec−D_acous, where S_time is the time shift, D_elec is an electrical delay in the hearing device, and D_acous an acoustic delay. The time delay may be D_time=0 if S_time<D_elec+D_acous. Thus, the time delay D_time may be set to zero if the sum of electrical delay and acoustic delay is larger than the time shift S_time.

In one or more examples, the hearing device is configured to determine a confidence score. The confidence score may be indicative of a confidence of the time shift. To determine the time delay based on the time shift may comprise to determine the time delay based on the time shift and the confidence score.

In one or more examples, the hearing device is configured to optionally determine and transmit a first delay control signal to a contralateral hearing device. The first delay control signal may be indicative of the time shift and/or the time delay, e.g. determined in or of the hearing device. Thus, in one or more examples the first delay control signal is indicative of the time shift detected/estimated in the hearing device. Alternatively, or in combination, in one or more examples, the first delay control signal is indicative of the time delay of the hearing device/time-delay estimator.

The contralateral hearing device may be a second hearing device. The contralateral hearing device may be a second hearing device in the other ear of the user, i.e. when the user wears a hearing device in both ears, i.e. a binaural hearing device system. Thereby an effective binaural processing is facilitated by enabling the hearing devices of the binaural hearing device system to maintain localization cues, in particular if the second input signal is delayed.

In one or more example contralateral hearing devices, a contralateral hearing device, also denoted second hearing device, comprises an interface, and a processor. The second/contralateral) hearing device may be configured to obtain a microphone input signal from a microphone of the second/contralateral) hearing device. The second/contralateral) hearing device may be configured to obtain a transceiver input signal from a transceiver of the interface of the second/contralateral) hearing device. The second/contralateral) hearing device may be configured to determine, e.g. using the processor, a time shift between the microphone input signal and the transceiver input signal of the second/ contralateral) hearing device. The (second/contralateral) hearing device may be configured to determine, e.g. using the processor, a time delay based on the time shift of the (second/contralateral) hearing device. The (second/contralateral) hearing device may be configured to process, e.g. using the processor, the transceiver input signal for provision of an output signal, wherein to process the transceiver input signal optionally comprises to apply the time delay to the transceiver input signal for provision of a delayed transceiver input signal of the (second/contralateral) hearing device. The (second/contralateral) hearing device may be configured to provide the output signal to a receiver of the (second/contralateral) hearing device for provision of an audio output signal, wherein the time delay is optionally determined to align the audio output signal with an acoustic input signal of the (second/contralateral) hearing device.

In one or more examples, the (first) hearing device is configured to obtain, e.g. via the transceiver, a contralateral input signal from a contralateral hearing device. The contralateral input signal may comprise a contralateral delay control signal, e.g. indicative of (contralateral) time shift and/or (contralateral) time delay of the contralateral hearing device. To determine the time delay of the (first) hearing device may be based on the (contralateral) delay control signal. The (contralateral) delay control signal may be indicative of a time delay, a time shift and/or a confidence score determined by the contralateral hearing device.

In one or more examples, a hearing system comprising a first hearing device and a second hearing device is disclosed. The first hearing device may be a hearing device as described herein. Thus, the first hearing device may a hearing device comprising an interface, and a processor, wherein the hearing device is configured to obtain a microphone input signal from a microphone of the first hearing device; obtain a transceiver input signal from a transceiver of the interface; determine a time shift between the microphone input signal and the transceiver input signal; determine a time delay based on the time shift; process the transceiver input signal for provision of an output signal, wherein to process the transceiver input signal comprises to apply the time delay to the transceiver input signal for provision of a delayed transceiver input signal; and provide the output signal to a receiver of the first hearing device for provision of an audio output signal, wherein the time delay is determined to align the audio output signal with an acoustic input signal.

In one or more example hearing systems, a hearing system comprises a first hearing device and a second hearing device, wherein the first hearing device is a hearing device as described herein.

It is noted that descriptions and features of hearing device functionality, such as hearing device configured to, also apply to methods and vice versa. For example, a description of a hearing device configured to enter a pairing mode for pairing to an accessory device also applies to a method of operating a hearing device, wherein the method comprises entering a pairing mode for pairing to an accessory device, and vice versa. The hearing device disclosed herein may be configured to perform any of the methods herein.

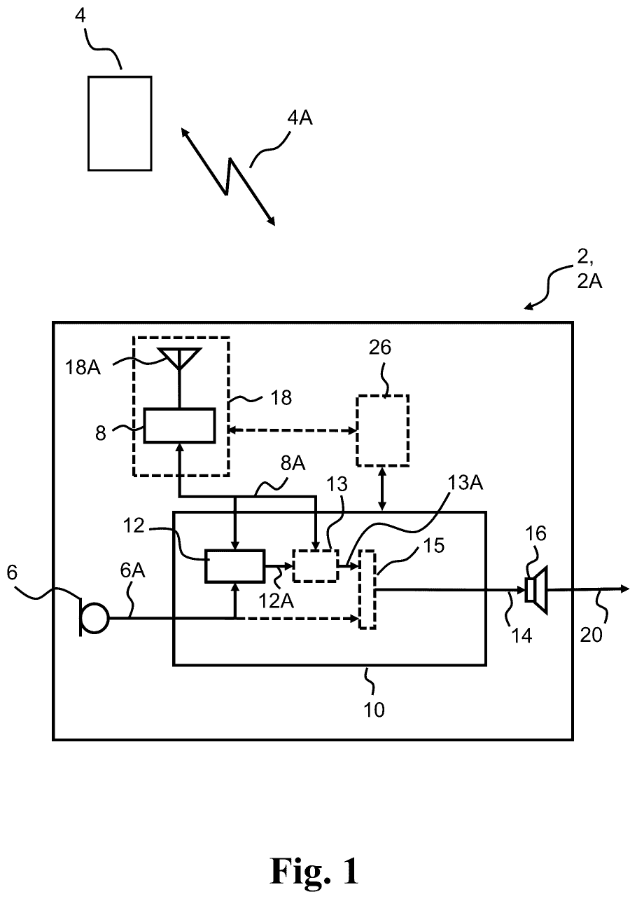

FIG. 1 schematically illustrates an exemplary hearing device 2, such as first hearing device 2A, according to this disclosure. The hearing device 2 comprises an interface and a processor 10. The hearing device comprises a microphone 6, such as a first microphone, for provision of a (first) microphone input signal 6A. Optionally, the hearing device comprises a second microphone for provision of a second microphone input signal, e.g. wherein the microphone input signal is based on the second microphone input signal. Thus, first microphone input signal may form the microphone input signal or the microphone input signal may be based on the first microphone input signal and the second microphone input signal.

The interface further comprises a transceiver 8, such as a first transceiver, for provision of a transceiver input signal 8A.

The transceiver 8 may be part of a first wireless communication unit 18. The communication unit 18 optionally comprises an antenna 18A coupled to the first wireless communication unit 18 with the transceiver 8. The antenna 18A may be configured for wireless communication, e.g. with one or more accessory devices, such as accessory device 4, and/or a contralateral hearing device. The antenna 18A may optionally be configured for receiving one or more wireless input signals 4A, e.g. a first wireless input signal and/or a second wireless input signal, from the accessory device 4. The wireless input signal(s) 4A may origin from external audio source(s), such as audio devices, e.g. spouse microphone device(s), wireless TV audio transmitter(s), music player(s), car(s), doorbell(s), mobile phone(s), smart watch(es), and wireless audio transmitters(s), such as public wireless audio transmitter(s), e.g. in airports, train stations, stadiums, cinemas, shopping malls, lectures, during religious services e.g. in churches, and/or arenas. The accessory device 4 may operate, be, and/or function as an audio device. The accessory device 4 may be a microphone system, a tablet computer, a laptop computer, a smartphone, and/or a smart watch. The transceiver 8 is configured to convert wireless input signal(s), including a first wireless input signal 4A, from the accessory device 4 to one or more transceiver input signals 8A.

The hearing device 2/processor 10 is configured to, e.g. via time-delay determiner 12, determine a time shift between the microphone input signal 6A and the transceiver input signal 8A, and determine a time delay 12A based on the time shift. Thus, the hearing device 2 is configured to determine a time delay 12A based on the time shift between the microphone input signal 6A and the transceiver input signal 8A.

The time-delay determiner 12 may be implemented separate from or as an integrated part of processor 10 and may be configured to perform a cross-correlation on the microphone input signal 6A and the transceiver input signal 8A for provision of the time shift. In other words, to determine a time shift S_time between the microphone input signal 6A and the transceiver input signal 8A may comprise to perform a cross correlation function on the microphone input signal 6A and the transceiver input signal 8A. If the microphone input signal 6A is before the transceiver input signal 8A, the time shift and/or the time delay 12A may be set to zero. Thus, determining the time delay 12A may comprise to determine whether the microphone input signal 6A is before the transceiver input signal 8A, and in response to a determination that the microphone input signal 6A is before the transceiver input signal 8A, the time delay 12A may be set to zero. If the microphone input signal 6A is after the transceiver input signal 8A, the time delay 12B may be larger than zero.

The time delay 12A is optionally based on an electrical delay, e.g. processing delay in processor 10. The time delay 12A may be based both on the time shift and the electrical delay. The time delay may be the sum of the time shift and the electrical delay. If the electrical delay is larger than the time shift, the time delay 12A is normally set to zero.

The time delay 12A may, e.g. in combination with the electrical delay, be based on an acoustic delay. The time delay 12A may be based both on the time shift, the acoustic delay, and the electrical delay. The time delay may be set as the time shift minus the acoustic delay and minus the electrical delay. If the sum of the electrical delay and the acoustic delay is larger than the time shift, the time delay may be set to zero.

The hearing device 2, such as the processor 10, is configured to process the transceiver input signal 8A for provision of an output signal 14. To process the transceiver input signal 8A comprises to apply the time delay 12A to the transceiver input signal 8A, e.g. in delay unit 13, for provision of a delayed transceiver input signal 13A. The delayed transceiver input signal 13A is optionally further processed in processor 10, such as combined with microphone input signal 6A and/or compensated for hearing loss, e.g. for provision of output signal 14. In other words, the delayed transceiver input signal 13A may form the output signal 14, or the delayed transceiver input signal 13A and the microphone input signal 6A may be combined, e.g. prior to or after hearing loss compensation, in hearing loss compensator 15.

The hearing device comprises a receiver 16. The hearing device 2/processor 10 is configured to provide the output signal 14 to the receiver 16 for provision of an audio output signal 20.

The time delay 12A may be determined to align the audio output signal 20 with an acoustic input signal, such as received by the microphone(s). The acoustic input signal may be ambient sound, also known as background noise, natural sound, and/or atmospheric sound from the surroundings. Presetting a time delay to account for any estimated delays involved with wireless audio broadcasting from e.g. a spouse microphone, may therefore be avoided since the time delay is determined by the hearing device 2. If there are variations in the wireless audio broadcasting and the acoustic input signal, the time delay is adjusted accordingly by the hearing device 2, e.g. by the time delay being determined to align the audio output signal with the acoustic input signal.

The time delay 12A may be based on an electrical delay comprising one or more of a receiver delay associated with the receiver 16 and a processing delay associated with the processor 10. Thus, the electrical delay may comprise a receiver delay associated with the receiver 16 and a processing delay associated with the processor 10. In other words, the electrical delay may be comprising a receiver delay associated with the receiver 16. Alternatively, or in combination, the electrical delay may be comprising a processing delay associated with the processor 10, such as one or more of time-delay determiner 12, delay unit 13, and hearing loss compensator 15.

The hearing device 2 may be configured to determine a confidence score indicative of a confidence of the time shift. To determine the time delay 12A based on the time shift may comprise to determine the time delay based on the time shift and the confidence score. The time delay and the confidence score may sum up to the time shift.

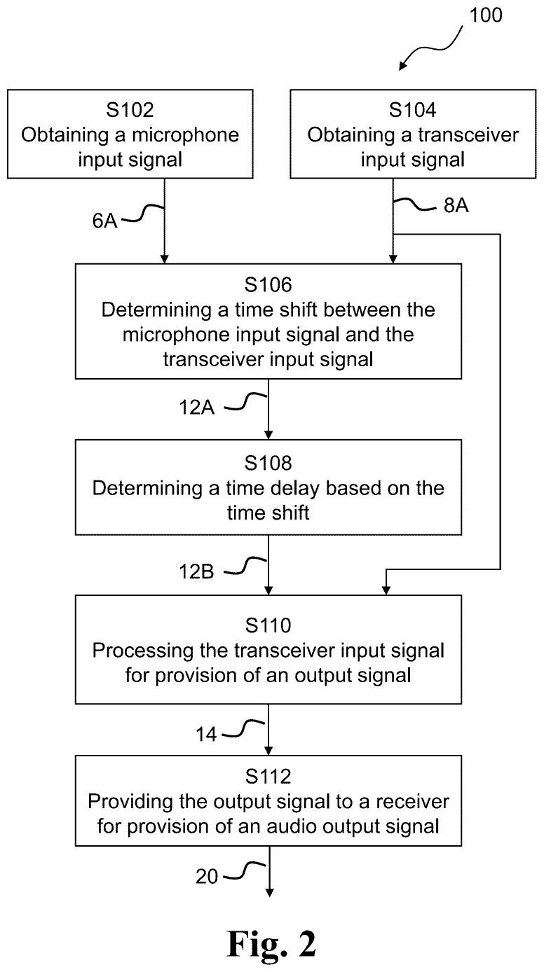

FIG. 2 is a diagram 100 illustrating an example method of operating a hearing device 2, such as first hearing device 2A, comprising an interface, and a processor 10. The method 100 comprises obtaining S102, from a microphone 6 or from a plurality of microphones of the hearing device, a microphone input signal 6A, and obtaining S104, from a transceiver 8 of the interface, a transceiver input signal 8A. The transceiver 8 may be a first transceiver. The transceiver 8 may be part of a first wireless communication unit 18 also comprising an antenna 18A configured for wireless communication, e.g. with one or more accessory devices, such as accessory device 4, and/or a contralateral hearing device. The antenna 18A may optionally be configured for receiving one or more wireless input signals 4A, e.g. a first wireless input signal and/or a second wireless input signal, from the accessory device 4. The wireless input signal(s) 4A may origin from external audio source(s), such as audio devices, e.g. spouse microphone device(s), wireless TV audio transmitter(s), music player(s), car(s), doorbell(s), mobile phone(s), smart watch(es), and wireless audio transmitters(s), such as public wireless audio transmitter(s), e.g. in airports, train stations, stadiums, cinemas, shopping malls, lectures, during religious services e.g. in churches, and/or arenas. The accessory device 4 may operate, be, and/or function as an audio device. The accessory device 4 may be a microphone system, a tablet computer, a laptop computer, a smartphone, and/or a smart watch. The transceiver 8 is configured to convert wireless input signal(s), including a first wireless input signal 4A, from the accessory device 4 to one or more transceiver input signals 8A.

The method illustrated in FIG. 2 comprises determining S106 a time shift between the microphone input signal 6A and the transceiver input signal 8A. Determining S106 a time shift between the microphone input signal 6A and the transceiver input signal 8A, may comprise using the processor 10, such as a time-delay estimator 12.

The method illustrated in FIG. 2 comprises determining S108 a time delay based on the time shift. Determining S108 the time delay based on the time shift, may comprise using the processor 10, such as a time-delay estimator 12.

The method illustrated in FIG. 2 comprises processing S110 the transceiver input signal 8A for provision of an output signal 14. Processing S110 the transceiver input signal 8A for provision of an output signal 14 comprises applying the time delay to the transceiver input signal 8A for provision of a delayed transceiver input signal 8B. Processing S110 the transceiver input signal 8A for provision of an output signal 14 optionally comprises applying hearing compensation. Processing S110 the transceiver input signal 8A for provision of an output signal 14 optionally comprises combining the microphone input signal and the delayed transceiver input signal. In other words, the output signal may be based on the microphone input signal and the delayed transceiver input signal. Processing S110 the transceiver input signal 8A for provision of an output signal 14 may comprise using the processor 10.

The method illustrated in FIG. 2 comprises providing S112 the output signal 14 to a receiver 16 of the hearing device for provision of an audio output signal 20. The time delay is determined to align the audio output signal with an acoustic input signal. The acoustic input signal may be an ambient sound, also known as background noise, natural sound, and/or atmospheric sound from the surroundings. Presetting of a time delay to account for any estimated delays involved with wireless audio broadcasting from e.g. a microphone, may therefore be avoided since the time delay is determined by the hearing device. If there are variations in the wireless audio broadcasting and the acoustic input signal, the time delay is adjusted accordingly by the hearing device 2 by the time delay being determined to align the audio output signal with the acoustic input signal.

As shown in FIG. 1, the hearing device may comprise a memory 26. The processor 10, such as the time-delay estimator 12, delay unit 13, and/or hearing loss compensator 15, is optionally configured to perform any of the operations disclosed in FIG. 2, such as any one or more of: S102, S104, S106, S108, S110, S112. The operations of the processor 10 may be embodied in the form of executable logic routines, e.g., lines of code, software programs, etc., that are stored on a non-transitory computer readable medium, e.g., the memory 26, and are executed by the processor 10.

Furthermore, the operations of the hearing device 2 may be considered a method that the hearing device 2 is configured to carry out. Also, while the described functions and operations may be implemented in software, such functionality may as well be carried out via dedicated hardware or firmware, or some combination of hardware, firmware and/or software.

The memory 26 may be one or more of a buffer, a flash memory, a hard drive, a removable media, a volatile memory, a non-volatile memory, a random access memory (RAM), or other suitable device. In a typical arrangement, the memory 26 may include a non-volatile memory for long term data storage and a volatile memory that functions as system memory for the processor 10. The memory 26 may exchange data with the processor 10 over a data bus (not shown). Control lines and an address bus between the memory 26 and the processor 10 also may be present (not shown in FIG. 1). The memory 26 is considered a non-transitory computer readable medium.

The hearing device/interface may be configured for wireless communication with one or more audio devices also denoted audio sources and/or one or more hearing devices, such as a contralateral hearing device.

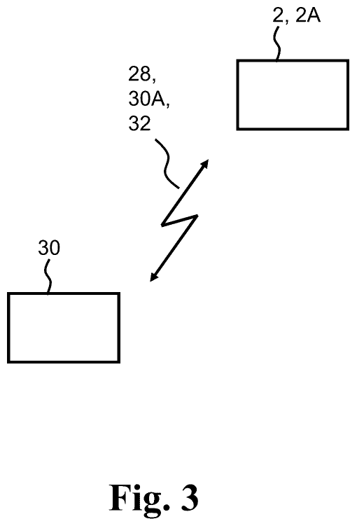

FIG. 3 shows the wireless communication between the hearing device 2, such as the first hearing device 2A, and a contralateral hearing device 30, such as a second hearing device. The contralateral hearing device 30 may comprise an interface and a processor as described in FIGS. 1 and 2 for the (first) hearing device 2. In other words, the hearing device/interface of each of the (first) hearing device 2, 2A and the contralateral hearing device 30 may be configured for wireless communication with the other hearing device. The hearing device/interface of each of the (first) hearing device 2 and the contralateral hearing device 30 optionally comprises an antenna for converting one or more wireless input signals 4A, e.g. a first wireless input signal and/or a second wireless input signal, to antenna output signal(s). The wireless input signal(s) 4A comprises or are representative of audio data, e.g. the first audio data and/or second audio data. In other words, the audio data may be encoded in the wireless input signal(s). The wireless input signal(s) 4A may origin from external audio source(s) 4, such as audio devices, e.g. spouse microphone device(s), wireless TV audio transmitter(s), music player(s), car(s), doorbell(s), mobile phone(s), smart watch(es), and wireless audio transmitters(s), such as public wireless audio transmitter(s), e.g. in airports, train stations, stadiums, cinemas, and/or arenas. The wireless input signal(s) 4A may origin from one or more accessory devices 4.

The (first) hearing device 2 and contralateral hearing device 30 may be configured to obtain signals from the other hearing device of the first) hearing device 2 and contralateral hearing device 30.

Optionally, as shown in FIG. 3, the (first) hearing device 2 is configured to determine and transmit a delay control signal 28 to a contralateral hearing device 30. The delay control signal 28 may be indicative of the time shift and/or the time delay as obtained by the (first) hearing device 2. The delay control signal 28 as obtained by the (first) hearing device 2 may be utilised for obtaining an effective syncronization between the (first) hearing device 2 and the contralateral hearing device 30.

The transceiver input signal 8A may comprise a delay control signal, such as the delay control signal 28 as obtained by the (first) hearing device 2. To determine the time delay may therefore be based on the delay control signal.

Optionally, as shown in FIG. 3, the (first) hearing device 2 is configured to obtain a contralateral input signal 30A from the contralateral hearing device 30. Thus, the contralateral hearing device 30 may be configured to transmit a contralateral input signal 30A to the (first) hearing device 2. The contralateral input signal 30A may comprise, or be indicative of a delay control signal 32, such as a contralateral delay control signal. Determine the time delay in the (first) hearing device 2 may be based on the (contralateral) delay control signal 32.

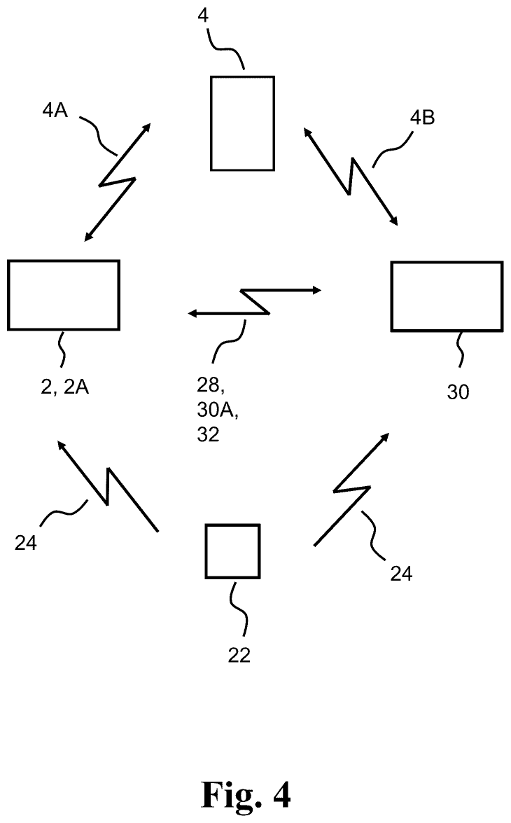

FIG. 4 shows the wireless communication between the hearing device 2, such as the first hearing device 2A, a contralateral hearing device 30, such as a second hearing device, and an accessory device 4. The accessory device 4 may operate, be, and/or function as an audio device. The (first) hearing device 2 and the contralateral hearing device 30, such as the second hearing device optionally comprises an antenna for converting one or more wireless input signals to antenna output signal(s). The wireless input signal(s) comprises or are representative of audio data, e.g. the first audio data and/or second audio data. In other words, the audio data may be encoded in the wireless input signal(s). The wireless input signal(s) may origin from external audio source(s), such as audio devices, e.g. spouse microphone device(s), wireless TV audio transmitter(s), music player(s), car(s), doorbell(s), mobile phone(s), smart watch(es), and wireless audio transmitters(s), such as public wireless audio transmitter(s), e.g. in airports, train stations, stadiums, cinemas, shopping malls, lectures, during religious services e.g. in churches, and/or arenas. The (first) hearing device 2, and the contralateral hearing device 30 may comprise an interface and a processor as described in FIGS. 1-3. In other words, the hearing device/interface of each of the (first) hearing device 2 and the contralateral hearing device 30 may be configured for wireless communication with the other hearing device. The hearing device/interface of each of the (first) hearing device 2 and the contralateral hearing device 30 optionally comprises an antenna for converting one or more wireless input signals, e.g. a first wireless input signal 4A and/or a second wireless input signal 4B, to antenna output signal(s). The (first) hearing device 2 and contralateral hearing device 30 may be configured to obtain signals from the other hearing device of the (first) hearing device 2 and contralateral hearing device 30, and/or from the accessory device 4.

Optionally, as shown in FIG. 4, the (first) hearing device 2 is configured to transmit a delay control signal 28 to a contralateral hearing device 30, and to obtain a contralateral input signal 30A from the contralateral hearing device 30 as described in connection with FIG. 3.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering.

Furthermore, the labelling of a first element does not imply the presence of a second element and vice versa.

It may be appreciated that FIGS. 1-4 comprise some modules or operations which are illustrated with a solid line and some modules or operations which are illustrated with a dashed line. The modules or operations which are comprised in a solid line are modules or operations which are comprised in a broad example embodiment. The modules or operations which are comprised in a dashed line are example embodiments which may be comprised in, or a part of, or are further modules or operations which may be taken in addition to the modules or operations of the solid line example embodiments. It should be appreciated that these operations need not be performed in order presented. Furthermore, it should be appreciated that not all of the operations need to be performed. The exemplary operations may be performed in any order and in any combination.

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the exemplary embodiments may be implemented at least in part by means of both hardware and software, and that several “means”, “units” or “devices” may be represented by the same item of hardware.

The various exemplary methods, devices, and systems described herein are described in the general context of method steps processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform specified tasks or implement specific abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed invention, and it will be made obvious to those skilled in the art that various changes and modifications may be made without departing from the spirit and scope of the claimed invention. The specification and drawings are, accordingly to be regarded in an illustrative rather than restrictive sense. The claimed invention is intended to cover all alternatives, modifications, and equivalents.

### LIST OF REFERENCES

2 hearing device
2A first hearing device
4 accessory device
4A wireless input signal
6 microphone, first microphone
6A microphone input signal, first microphone input signal
8 transceiver
8A transceiver input signal
8B delayed transceiver input signal
10 processor
12 time-delay determiner
12A time delay
13 delay unit
13A delayed transceiver input signal
14 output signal
15 hearing loss compensator
16 receiver
18 wireless communication unit
18A antenna
20 audio output signal
26 memory
28 delay control signal
30 contralateral hearing device
30A contralateral input signal
32 delay control signal of the contralateral hearing device

1. A hearing device comprising:
a transceiver configured to provide a transceiver input signal;
a microphone configured to provide a microphone input signal;
a processor configured to determine a time shift between the microphone input signal and the transceiver input signal, and to determine a time delay based on the time shift, wherein the processor is configured to process the transceiver input signal for provision of an output signal, wherein the processor is configured to process the transceiver input signal by applying the time delay to the transceiver input signal for provision of a delayed transceiver input signal; and
a receiver configured to provide an audio output signal based on the output signal, wherein the time delay is to align the audio output signal with an acoustic input signal.

2. The hearing device according to claim 1, wherein the processor is configured to determine the time delay by determine whether the microphone input signal is before the transceiver input signal, and to set the time shift and/or the time delay to zero if the microphone input signal is before the transceiver input signal.

3. The hearing device according to claim 1, wherein the hearing device is configured to transmit a first delay control signal to a contralateral hearing device, the first delay control signal being indicative of the time shift and/or the time delay.

4. The hearing device according to claim 1, wherein the transceiver input signal comprises a transmitter delay control signal, and wherein the processor is configured to determine the time delay based on the transmitter delay control signal.

5. The hearing device according to claim 1, wherein the hearing device is configured to obtain a contralateral input signal from a contralateral hearing device, the contralateral input signal comprising a contralateral delay control signal.

6. The hearing device according to claim 5, wherein the processor is configured to determine the time delay based on the contralateral delay control signal.

7. The hearing device according to claim 1, wherein the time delay is based on a receiver delay associated with the receiver and/or a processing delay associated with the processor.

8. The hearing device according to claim 1, wherein the processor is configured to determine the time shift between the microphone input signal and the transceiver input signal by performing a cross correlation function on the microphone input signal and the transceiver input signal.

9. The hearing device according to claim 1, wherein the time delay T_D is given by: T_D=t_s−D_elec, where t_s is the time shift and D_elec is an electrical delay in the hearing device.

10. The hearing device according to claim 1, wherein the hearing device is configured to determine a confidence score indicative of a confidence of the time shift, and wherein the processor is configured to determine the time delay based on the time shift and the confidence score.

11. The hearing device according to claim 1, wherein the processor comprises hardware and/or software.

12. The hearing device according to claim 1, wherein the processor comprises one or more processing units.

13. A hearing system comprising a first hearing device and a second hearing device, wherein the first hearing device is the hearing device according to claim 1.

14. A method performed by a hearing device, the method comprising:
providing, by a microphone of the hearing device, a microphone input signal;
providing, by a transceiver of the hearing device, a transceiver input signal;
determining a time shift between the microphone input signal and the transceiver input signal;
determining a time delay based on the time shift;
processing the transceiver input signal for provision of an output signal, wherein the act of processing the transceiver input signal comprises applying the time delay to the transceiver input signal for provision of a delayed transceiver input signal; and
providing, by a receiver of the hearing device, an audio output signal based on the output signal, wherein the time delay is to align the audio output signal with an acoustic input signal.

15. The method according to claim 14, further comprising transmitting a first delay control signal to a contralateral hearing device, the first delay control signal being indicative of the time shift and/or the time delay.

16. The method according to claim 14, wherein the transceiver input signal comprises a transmitter delay control signal, and wherein the time delay is determined based on the transmitter delay control signal.

17. The method according to claim 14, further comprising obtaining a contralateral input signal from a contralateral hearing device, the contralateral input signal comprising a contralateral delay control signal.

18. The method according to claim 17, wherein the time delay is determined based on the contralateral delay control signal.

19. The method according to claim 14, wherein the act of determining the time shift between the microphone input signal and the transceiver input signal comprises performing a cross correlation function on the microphone input signal and the transceiver input signal.

20. The method according to claim 14, further comprising determining a confidence score indicative of a confidence of the time shift, and wherein the time delay is determined based on the time shift and the confidence score.
